(19) United States
(12) Patent Application Publication
(10) Pub. No.: US 2011/0182641 A1
(43) Pub. Date: Jul. 28, 2011

(54) DOCUMENT FEEDER AND IMAGE FORMING APPARATUS

(76) Inventors: Kazuhiko Yamakawa, Osaka (JP); Masao Matsui, Osaka (JP)

(21) Appl. No.: 12/987,191

(22) Filed: Jan. 10, 2011

(30) Foreign Application Priority Data
Jan. 27, 2010 (JP) 2010-015647

(51) Int. Cl. G03G 15/00; B65H 5/00

(52) U.S. Cl. 399/367; 271/264

(57) ABSTRACT

A document feeder includes a document load tray, a duct, a ventilating section, and an ion generating device. The document load tray is a member for loading thereon a document to be read and has a hole extending therethrough to provide communication between a document load side of the document load tray and a reverse side of the document load tray which is opposite away from the document load side. The duct is placed on the reverse side of the document load tray continuously with the hole. The ventilating section is configured to feed air present outside an image forming apparatus into the duct through an opening of the duct. The ion generating device is disposed within the duct and configured to generate ions for cleaning up the air fed into the duct by the ventilating section.

### CROSS REFERENCE

This Nonprovisional application claims priority under 35 U.S.C. §119(a) on Patent Application No. 2010-015647 filed in Japan on Jan. 27, 2010, the entire contents of which are hereby incorporated by reference.

### BACKGROUND OF THE INVENTION

The present invention relates to a document feeder having an ion generating device for air cleaning, as well as an image forming apparatus provided with such a document feeder.

In recent years, electrophotographic image forming apparatuses capable of image formation, including copiers, printers and facsimile apparatuses, have been developed. These image forming apparatuses are of the type configured to carry out an image forming process on a so-called “recording sheet”, the image forming process including: for example, forming an electrostatic latent image on the surface a photoreceptor drum; developing the electrostatic latent image to form a toner image on the surface of the photoreceptor drum; transferring the toner image onto a recording sheet; and fixing the toner image to the recording sheet by heating and pressurizing the recording sheet.

Such an image forming apparatus sometimes produces exhaust gas during the image forming process on the recording sheet. The exhaust gas comprises longifolene, ozone, toner smell, or the like produced from the recording sheet and is known to give off a nasty smell.

However, such image forming apparatuses are indispensable office automation equipment for offices and the like and hence are installed in most of existing offices and are spreading even to homes and hospitals. For this reason, the exhaust gas produced from the image forming apparatuses makes numerous users feel unpleasant.

In order to clean up such exhaust gas from produced image forming apparatuses, various proposals have been made so far. For example, one known image forming apparatus is interiorly provided with an air fan, a negative ion generating device and a positively charged filter which are disposed inside a duct and is configured to introduce outside air through an intake vent of the duct, reduce harmful substances contained in the air thus introduced by means of the negative ion generating device and the positively charged filter, and then exhaust the air out of the apparatus (see Japanese Patent Laid-Open Publication No. 2005-004144).

The image forming apparatus described in Japanese Patent Laid-Open Publication No. 2005-004144 noted above employs an arrangement for mixing outside air with air present inside the image forming apparatus and then cleaning up the mixed air by using the negative ion generating device and the positively charged filter before exhaust. With this arrangement, an ion generation impeding substance, such as silicon, produced from the fixing section is mixed into outside air and, hence, the ion generating efficiency of the negative ion generating device is lowered by the action of silicon or the like. Therefore, ambient air around the image forming apparatus body can not efficiently be cleaned up.

In view of the problem described above, the present invention intends to provide a document feeder capable of efficiently cleaning up ambient air around the image forming apparatus body by keeping the ion generating efficiency of the ion generating device at a high level.

### SUMMARY OF THE INVENTION

A document feeder according to the present invention is provided on an image forming apparatus body to serve as a part of the image forming apparatus. The document feeder comprises a document load tray, a duct, a ventilating section, and an ion generating device.

The document load tray is a member for loading thereon a document to be read and has a hole extending therethrough to provide communication between a document load side of the document load tray and a reverse side of the document load tray which is opposite away from the document load side. The duct is placed on the reverse side of the document load tray continuously with the hole. The ventilating section is configured feed air present outside the image forming apparatus body into the duct through an opening of the duct. The ion generating device is disposed within the duct and configured to generate ions for cleaning up the air fed into the duct by the ventilating section.

With this arrangement, air present around the document feeder is caused to pass the ion generating device in the duct by the ventilating section of the document feeder and, therefore, any ion generation impeding substance present in the image forming apparatus cannot be introduced into the duct. For this reason, the ion generating efficiency of the ion generating device can be kept high, which makes it possible to clean up ambient air around the image forming apparatus body efficiently.

These and other features and advantages of the present invention will become more apparent from the following detailed description of the invention in connection with the accompanying drawings.

### BRIEF DESCRIPTION OF THE DRAWINGS

FIG. 1 is a view illustrating the structure of an image forming apparatus provided with a document feeder according to a first embodiment of the present invention;

FIG. 2 is a view illustrating the structure of the document feeder according to the first embodiment of the present invention;

FIG. 3 is a view illustrating an arrangement on the reverse side of a document load tray included in the document feeder according to the first embodiment of the present invention;

FIG. 4 is a view illustrating the structure of a duct included in the document feeder according to the first embodiment of the present invention;

FIG. 5 is a fragmentary sectional view of the document load tray included in the document feeder according to the first embodiment of the present invention;

FIG. 6 is a view illustrating the structure of a document feeder according to a second embodiment of the present invention;

FIG. 7 is a view illustrating the structure of a document load tray included in the document feeder according to the second embodiment of the present invention;

FIG. 8 is a view illustrating the structure of a duct included in the document feeder according to the second embodiment of the present invention;

FIG. 9 is a view illustrating the structure of a document catch tray included in a document feeder according to a third embodiment of the present invention;

FIG. 10 is a block diagram illustrating part of the configuration of a document feeder according to a fourth embodiment of the present invention; and

FIG. 11 is a view illustrating the structure of a document load tray included in a document feeder according to a fifth embodiment of the present invention.

### DETAILED DESCRIPTION OF THE INVENTION

Hereinafter, document feeders according to embodiments of the present invention will be described in detail with reference to the drawings.

Description will be made of the first embodiment.

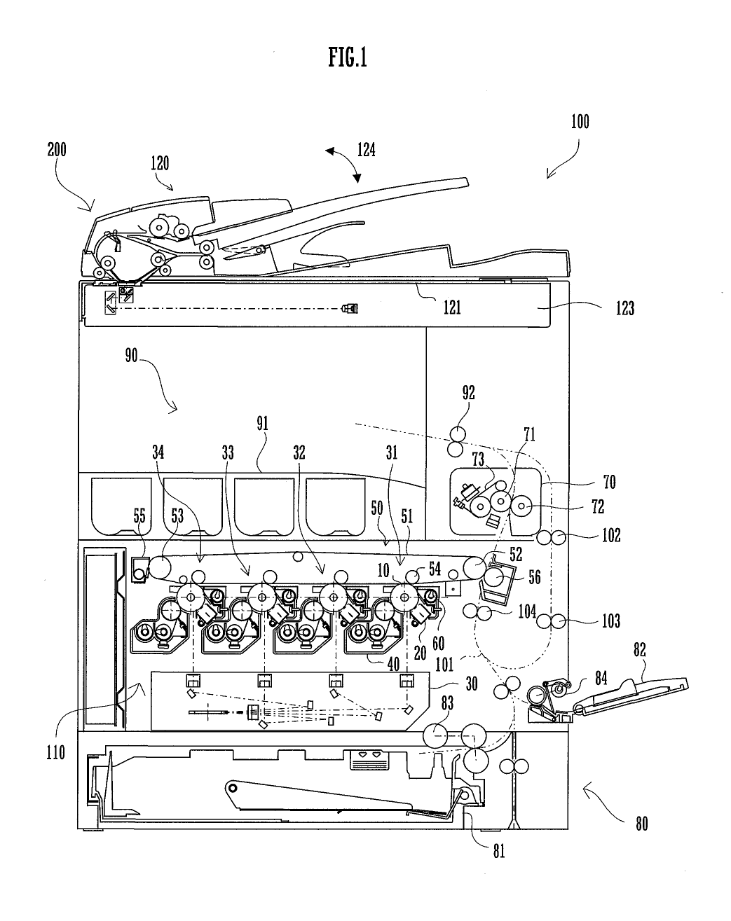

FIG. 1 is a view illustrating the structure of an image forming apparatus 100 provided with a document feeder 200 according to the first embodiment of the present invention.

The image forming apparatus 100 is configured to form a polychrome or monochrome image on a predetermined sheet (i.e., recording sheet) in accordance with image data transmitted thereto from the outside. The image forming apparatus 100 includes a document processing device 120, a sheet feeding section 80, an image forming section 110, and an output section 90.

The document processing device 120 includes a document platen 121, document feeder 200, and a document reading section 123. The document platen 121 is formed of transparent glass and is designed to allow a document to be placed thereon. The document feeder 200 feeds documents loaded on a document load tray 220 one by one. The document feeder 200, which is capable of pivoting in a direction indicated by arrow 124, allows a document to be placed on the document platen 121 by exposing the top surface of the document platen 121 to the outside. The document reading section 123 reads a document being fed by the document feeder 200 or a document placed on the document platen 122.

The sheet feeding section 80 includes a sheet feed cassette 81, a manual feed cassette 82, and pickup rollers 83 and 84. The sheet feed cassette 81 is a tray for storing standard size to sheets therein. The manual feed cassette 82 is a tray capable of receiving non-standard size sheets thereon. The pickup roller 83, which is located adjacent an end portion of the sheet feed cassette 81, picks up sheets one by one from the sheet feed cassette 81 to feed each sheet into a sheet feed path 101. Likewise, the pickup roller 84, which is located adjacent an end portion of the manual feed cassette 82, picks up sheets one by one from the manual feed cassette 82 to feed each sheet into the sheet feed path 101.

The image forming section 110 includes image forming stations 31 to 34, an exposure unit 30, an intermediate transfer belt unit 50, and a fixing unit 70. Each of the image forming stations 31 to 34 includes a photoreceptor drum 10, an electrostatic charger device 20, a developing device 40, and a cleaner unit 60. The image forming stations 31 to 34 correspond to respective colors, namely, black (K), cyan (C), magenta (M) and yellow (Y) and are each adapted to form a color image by using a respective one of the colors. In the present embodiment, description is directed to the image forming station 31.

The photoreceptor drum 10 rotates during image formation to bear a developer image thereon. Around the photoreceptor drum 10, there are disposed the electrostatic charger device 20, exposure unit 30, developing device 40, intermediate transfer belt unit 50 and cleaner unit 60 in this order from an upstream side in the direction of rotation of the photoreceptor drum 10. The fixing unit 70 is provided on the paper feed path 101 at a location most downstream in the image forming section 110.

The electrostatic charger device 20 is means for electrostatically charging a peripheral surface of the photoreceptor drum 10 to a predetermined potential uniformly. Besides the charger type as shown in FIG. 1, a contact-type electrostatic charger device using a roller or a brush may be used.

The exposure unit 30 has the function of exposing the photoreceptor drum 10 in an electrostatically charged state to light according to image data inputted, thereby forming an electrostatic latent image on the peripheral surface of the photoreceptor drum 10 according to the image data. The exposure unit 30 is constructed as a laser scanning unit (LSU) including a laser beam emitting section, a reflecting mirror and the like. In the exposure unit 30, there are disposed a polygon mirror for laser beam scanning and optical components, such as a lens and a mirror, for guiding laser light reflected by the polygon mirror to the photoreceptor drum 10. The exposure unit 30 may employ a technique using a writing head having an array of light-emitting devices of other type such as ELs or LEDs for example.

The developing device 40 is configured to visualize the electrostatic latent image formed on the photoreceptor drum 10.

The intermediate transfer belt unit 50 includes an intermediate transfer belt 51, an intermediate transfer belt driving roller 52, an intermediate transfer belt driven roller 53, an intermediate transfer roller 54, and an intermediate transfer belt cleaning unit 55.

The intermediate transfer belt driving roller 52, intermediate transfer belt driven roller 53 and intermediate transfer roller 54, about which the intermediate transfer belt 51 is entrained, drive the intermediate transfer belt 51 for rotation. The intermediate transfer roller 54 performs application of a transfer bias for transferring a toner image from the photoreceptor drum 10 onto the intermediate transfer belt 51.

The intermediate transfer belt 51 is positioned so as to contact the photoreceptor drum 10. The intermediate transfer belt 51 has the function of forming a toner image thereon by transfer of the toner image from the photoreceptor drum 10 onto the intermediate transfer belt 51. The intermediate transfer belt 51 is formed into an endless belt by using a film having a thickness of about 100 μm to about 150 μm for example.

The transfer of the toner image from the photoreceptor drum 10 to the intermediate transfer belt 51 is achieved by the intermediate transfer roller 54 in contact with the reverse side of the intermediate transfer belt 51. The intermediate transfer roller 54 is applied with a high transfer bias voltage (i.e., a high voltage having a polarity (+) opposite to the polarity (−) of the toner charged) in order to transfer the toner image. The intermediate transfer roller 54 is a roller comprising a shaft of metal (e.g., stainless steel) having a diameter of 8 to 10 mm as a base, and an electrically conductive elastic material (e.g., EPDM or urethane foam) covering the surface of the shaft. The electrically conductive elastic material enables the intermediate transfer belt 51 to be uniformly applied with the high voltage. While the present embodiment uses a transfer electrode in the form of a roller, it is possible to use a transfer electrode in the form of a brush or the like.

Electrostatic latent images thus visualized on the respective photoreceptor drums 10 are transferred onto the intermediate transfer belt 51 so as to be superimposed on one another. Image information obtained by the superimposition of the toner images is moved by rotation of the intermediate transfer belt 51 to a contact position between a sheet and the intermediate transfer belt 51 and is then transferred onto the sheet by the transfer roller 56 disposed at the contact position.

At that time, the intermediate transfer belt 51 and the transfer roller 56 are pressed against each other at a predetermined nip pressure, while the transfer roller 56 applied with the voltage for transferring the toner to the sheet (i.e., a high voltage having a polarity (+) opposite to the polarity (−) of the toner charged). For obtaining the nip pressure steadily, one of the transfer roller 56 and the intermediate transfer belt driving roller 52 comprises a hard material (e.g., metal or the like) and the other comprises a soft material such as an elastic roller (e.g., elastic rubber roller, expanded resin roller, or the like).

Toner thus attached to the intermediate transfer belt 51 by contact between the photoreceptor drum 10 and the intermediate transfer belt 51 or residual toner remaining on the intermediate transfer belt 51 without having been transferred onto the sheet by the transfer roller 56, is removed and recovered by the intermediate transfer belt cleaning unit 55. The intermediate transfer belt cleaning unit 55 includes, for example, a cleaning blade as a cleaning member for contact with the intermediate transfer belt 51. The intermediate transfer belt 51 contacted by the cleaning blade is supported by the intermediate transfer belt driven roller 53 from the reverse side thereof.

The cleaner unit 60 removes and recovers residual toner remaining on the peripheral surface of the photoreceptor drum 10 after the image transfer operation following the developing operation.

The fixing unit 70 includes a heating roller 71 and a pressurizing roller 72 which are configured to rotate while nipping a sheet therebetween. The heating roller 71 is controlled by a control section based on signals from a non-illustrated temperature detector so that a predetermined fixing temperature is reached. The heating roller 71 has the function of fusing, mixing and pressure-contacting the toner image transferred to the sheet by heat-bonding the toner to the sheet cooperatively with the pressurizing roller 71, thereby fixing the toner image onto the sheet by heat. An external heating belt 73 is provided for heating the heating roller 71 from the outside.

The output section 90 has a sheet catch tray 91 and sheet output rollers 92. The sheet having passed through the fixing unit 70 is outputted to the sheet catch tray 91 by passing between the sheet output rollers 92. The sheet catch tray 91 is a tray for accumulating thereon sheets finished with printing.

In cases where double-side printing is requested, when a sheet having been finished with single-side printing as described above and passed through the fixing unit 70 is held between the sheet output rollers 92 at its trailing edge, the sheet output rollers 92 rotate backwardly to feed the sheet to feed rollers 102 and then to feed rollers 103. Thereafter, the sheet is subjected to reverse side printing after having passed between registration rollers 104 and is then outputted to the sheet catch tray 91.

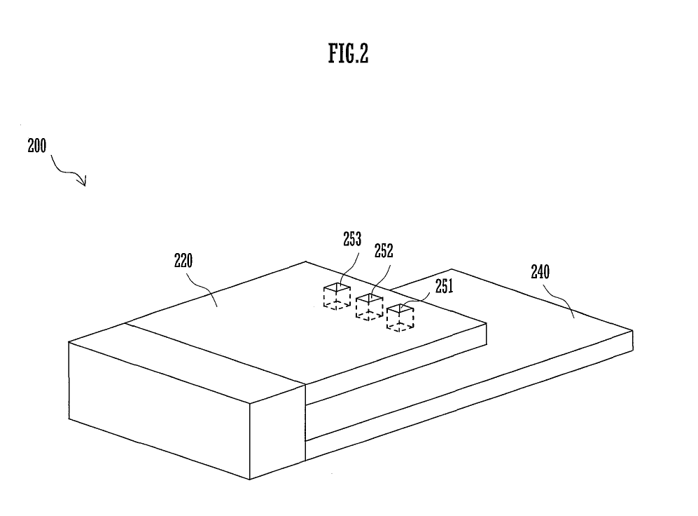

FIG. 2 is a view illustrating the structure of the document feeder 200 according to the first embodiment of the present invention.

The document feeder 200 is provided on the image forming apparatus 100 to serve as a part of the image forming apparatus 100. The document feeder 200 includes the document load tray 220 and a document catch tray 240. The document load tray 220 is a tray for loading thereon a document to be read. The document load tray 220 has holes 251 to 253 extending therethrough to provide communication between the document load side of the document load tray 220 and the reverse side of which document load tray 220 which is opposite away from the document load side. The document catch tray 240 is a tray for receiving thereon a document finished with reading.

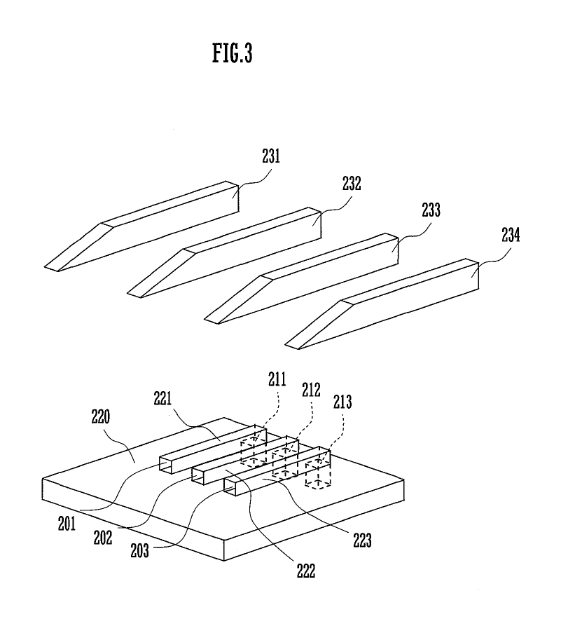

FIG. 3 is a view illustrating an arrangement on the reverse side of the document load tray 220 included in the document feeder 200 according to the first embodiment of the present invention.

Ducts 221 to 223 are arranged on the reverse side of the document load tray 220. The duct 221 is placed continuously with the hole 251. The duct 222 is placed continuously with the hole 252. The duct 223 is placed continuously with the hole 253.

FIG. 3 shows ribs 231 to 234 each positioned to extend longitudinally along each of the ducts 221 to 223, locating between each of the ducts 221 to 223 and at the both each side of the ducts 221 to 223. The ribs 231 to 234 will be described later.

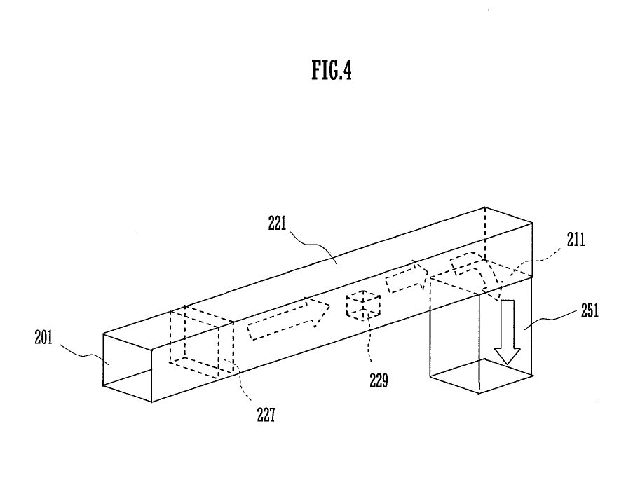

FIG. 4 is a view illustrating the structure of the duct 221 included in the document feeder 200 according to the first embodiment of the present invention.

Here, description is directed to the duct 221 of the three ducts. The duct 221 has a first end portion defining a first opening 201 for introducing air and a second end portion defining a second opening 211 for delivering air. The duct 221 defines an air flow path from the first opening 201 to the second opening 211. The duct 221 is provided therein with a ventilating section 227 and an ion generating device 229. The ventilating section 227 feeds air present outside the image forming apparatus 100 into the duct 221 through the first opening 201. That is, the ventilating section 227 sucks air present outside the image forming apparatus 100 into the duct 221 through the first opening 201, feeds the air to the second opening 211, and exhausts the air through the hole 251. At that time, the air passes the ion generating device 229.

The ion generating device 229 is disposed within the duct 221 and configured to generate ions for cleaning up air introduced into the duct 221 by the ventilating section 227. Therefore, air passing through the duct 221 is cleaned up by ions generated from the ion generating device 229 before being exhausted from the second opening 211. Because the air exhausted from the second opening 211 contains ions generated by the ion generating device 229, the ions can further clean up ambient air around the image forming apparatus 100.

With this arrangement, air introduced into the duct 221 by the ventilating section 227 fails to be mixed with air present inside the image forming apparatus 100 and, therefore, any ion generation impeding substance present inside the image forming apparatus 100, such as silicon, cannot pass the ion generating device 229. For this reason, the ion generating device 229 can generate ions efficiently.

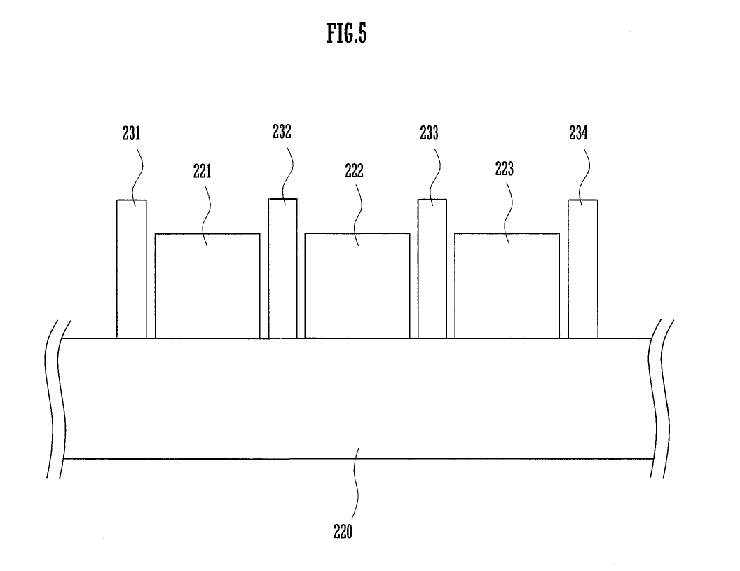

FIG. 5 is a fragmentary sectional view of the document load tray 220 included in the document feeder 200 according to the first embodiment of the present invention.

As has been described with reference to FIG. 3, the ribs 231 to 234 are arranged on the reverse side of the document load tray 220 which is opposite away from the document load side. Each of the ribs 231 to 234 is positioned to extend along each of opposite side edges of an associated one of the ducts 221 to 223. The ribs 231 to 234 have a larger height than the ducts 221 to 224.

As shown in FIG. 5, each of the ducts 221 to 223 is designed to be fitted between adjacent ribs. As shown in FIG. 3, each of the ribs 231 to 234 has an inclined surface for preventing a document ejected from the document feeder 200 from being caught on the ribs 231 to 234 and the ducts 221 to 224.

Therefore, in ejecting a document finished with reading onto the document catch tray 240, the document is prevented from being caught on the ducts.

Description will be made of the second embodiment.

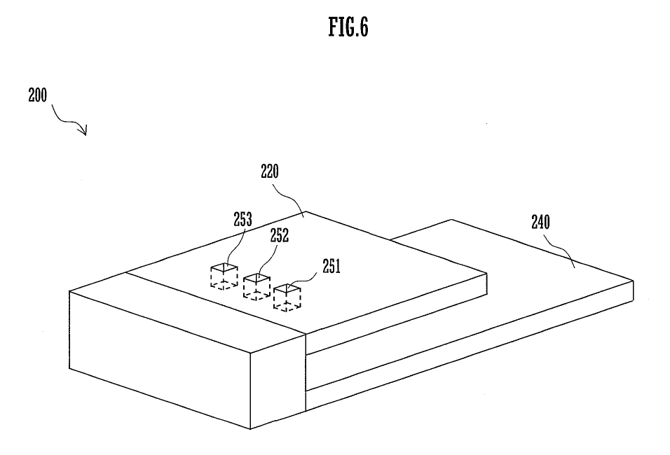

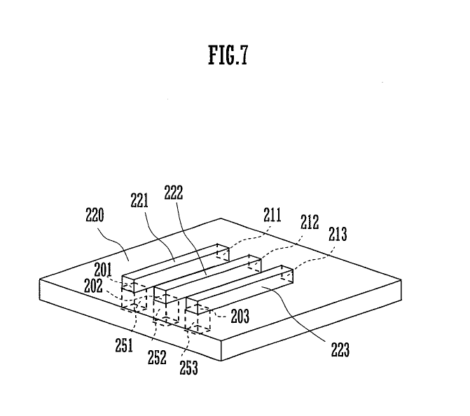

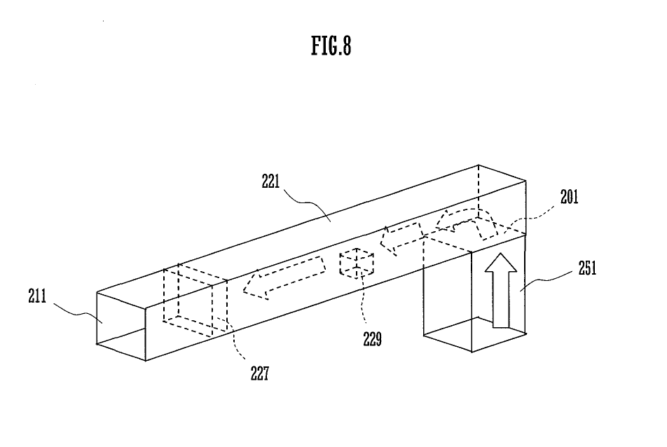

FIG. 6 is a view illustrating the structure of document feeder 200 according to the second embodiment of the present invention. FIG. 7 is a view illustrating an arrangement on the reverse side of document load tray 220 included in the document feeder 200 according to the second embodiment of the present invention. FIG. 8 is a view illustrating the structure of duct 221 included in the document feeder 200 according to the second embodiment of the present invention.

As shown in FIG. 6, the document load tray 220 according to the present embodiment has holes 251 to 253 extending therethrough to provide communication between the document load side of the document load tray 220 and the reverse side of the document load tray 220 which is opposite away from the document load side.

In the present embodiment also, ducts 221 to 223 are arranged on the document load tray 220 as shown in FIG. 7. The duct 221 is placed continuously with the hole 251. The duct 222 is placed continuously with the hole 252. The duct 223 is placed continuously with the hole 253.

Though the structure of the duct 221 according to the present embodiment is similar to that of the duct 221 according to the first embodiment, the direction of the air flow produced by the ventilating section 227 is opposite to that of the air flow in the first embodiment as shown in FIG. 8. Specifically, air flows from the hole 251 toward the first opening 201 of the duct 221 and then flows from the first opening 201 toward the second opening 211 of the duct 221.

That is, air cleaned up by the ion generating device 229 is exhausted from a lower portion of the document load tray 220. Therefore, this arrangement prevents the user present adjacent the image forming apparatus 100 from being exposed directly to the exhaust air and hence cannot make the user feel unpleasant.

Description will be made of the third embodiment.

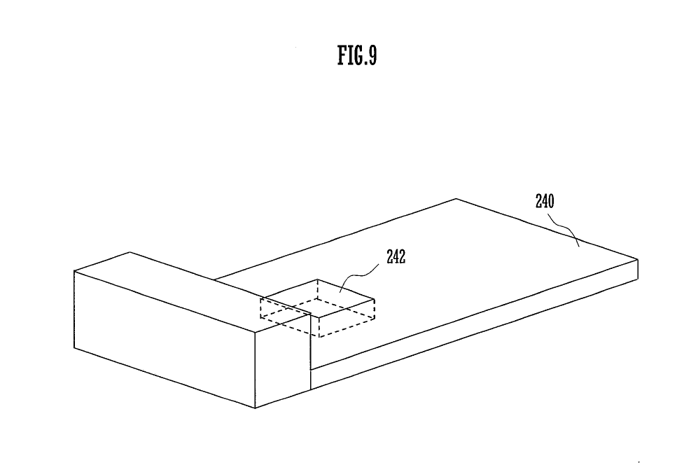

FIG. 9 is a view illustrating the structure of document catch tray 240 included in document feeder 200 according to the third embodiment of the present invention.

For convenience, document load tray 220 is not shown in FIG. 9. In the present embodiment, a ventilating section 242 is positioned so as to be capable of feeding air toward openings 225 of respective ducts 221 to 223 arranged on the document load tray 220 and the like. In this arrangement, there is no need to provide any ventilating section in each of the ducts 221 to 223.

According to the present embodiment, air is fed by the ventilating section 242 from the document catch tray 240 to the document load tray 220. Then, the air flows into each of the ducts 221 to 223 arranged on the document load tray 220 through one opening thereof, passes the ion generating device disposed in each of the ducts, and is then exhausted through the other opening.

This arrangement requires a lower parts count than the arrangement in which the ventilating section is disposed in each of the ducts 221 to 223 because a single ventilating section is sufficient to feed air into the ducts 221 to 223. Further, because the ventilating section 242 is embedded in the document catch tray 240, a document finished with reading is prevented from being caught on the ventilating section 242 when ejected onto the document catch tray 240.

Description will be made of the fourth embodiment.

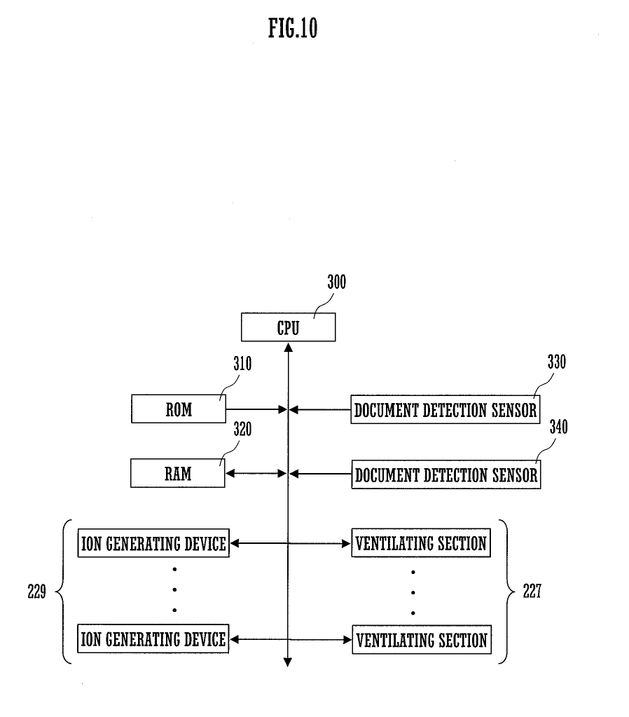

FIG. 10 is a block diagram illustrating part of the configuration of document feeder 200 according to the fourth embodiment of the present invention.

The document feeder 200 includes a CPU 300, ROM 310, RAM 320, document detection sensors 330 and 340, ventilating section 227, and ion generating device 229. The CPU 300 reads programs stored in the ROM 310 and executes the programs to control all the sections of the document feeder 200 integrally. The RAM 320 is used as a working area for the CPU 300. The document detection sensor 330 is provided on document load tray 220 and configured to detect the presence of a document on the document load tray 220. The document detection sensor 340 is provided on document catch tray 240 and configured to detect the presence of a document on the document catch tray 240.

When the CPU 300 determines that a document is absent from the document load tray 220 and the document catch tray 240 by monitoring detection signals from the document detection sensors 330 and 340, the CPU 300 performs a control such as to drive the ventilating section 227 and the ion generating device 229. On the other hand, when the CPU 300 determines that a document is present on the document load tray 220 or the document catch tray 240, the CPU 300 performs a control such as to drive neither the ventilating section 227 nor the ion generating device 229. That is, the CPU 300 determines whether or not the document feeder 200 is in use according to whether or not a document is present on the document load tray 220 or the document catch tray 240. When the document feeder 200 is not determined as being in use, the control section 300 performs a control such as to drive the ventilating section 227 and the ion generating device 229.

With this arrangement, the ventilating section 350 and the ion generating device 229 are driven only when a document is absent from the document load tray 220 and the document catch tray 240. For this reason, it is not possible that registration of a document placed on each of the document load tray 220 and the document catch tray 240 is disturbed by ventilation.

Finally, description will be made of the fifth embodiment.

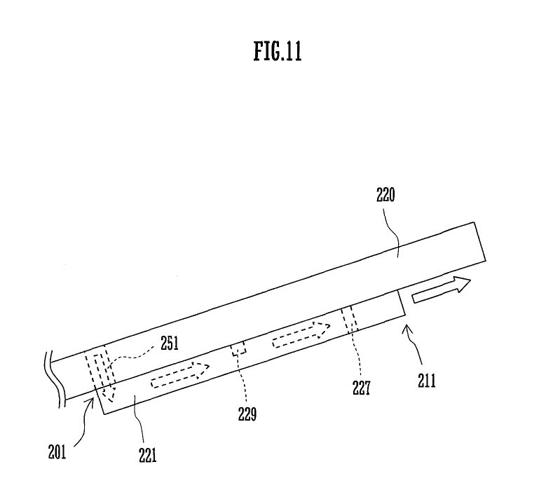

FIG. 11 is a view illustrating the structure of document load tray 220 included in document feeder 200 according to the fifth embodiment of the present invention.

Here, duct 221 provided on the document load tray 220 is described as an example. The document load tray 220 has an inclined surface formed such that a free end side of the document load tray 220 is positioned obliquely above a base end side of the document load tray 220. The duct 221 has first opening 201 located on the base end side of the document load tray 220 and second opening 211 located on the free end side of the document load tray 220. Since the second opening 211 of the duct 221 is oriented obliquely upward, air having passed the ion generating device 229 flows out obliquely upwardly.

With this arrangement, air containing ions generated by the ion generating device 229 flows out obliquely upwardly from the document load tray 220 to reach as far as the face of the user. Therefore, ambient air present around the image forming apparatus 100 can be cleaned up easily.

The first to fifth embodiments of the present invention have been described above. These embodiments may be combined as desired for use.

The foregoing embodiments are illustrative in all points and should not be construed to limit the present invention. The scope of the present invention is defined not by the foregoing embodiments but by the following claims. Further, the scope of the present invention is intended to include all modifications within the scopes of the claims and within the meanings and scopes of equivalents.

What is claimed is:

1. A document feeder provided on an image forming apparatus body to serve as a part of the image forming apparatus body, the document feeder comprising:
a document load tray for loading thereon a document to be read, the document load tray having a hole extending therethrough to provide communication between a document load side of the document load tray and a reverse side of the document load tray which is opposite away from the document load side;
a duct placed on the reverse side of the document load tray continuously with the hole;
a ventilating section configured to feed air present outside the image forming apparatus body into the duct through an opening of the duct; and
an ion generating device disposed within the duct and configured to generate ions for cleaning up the air fed into the duct by the ventilating section.

2. The document feeder according to claim 1, further comprising a control section configured to perform a control such that the ventilating section and the ion generating device are driven when a document is absent from a document feeder body.

3. The document feeder according to claim 1, wherein:
the duct has a first end portion defining a first opening for introducing air into the duct and a second end portion defining a second opening for delivering the air;
the document load tray has an inclined surface formed such that a free end side of the document load tray is positioned obliquely above a base end side of the document load tray; and
the duct extends in such a manner that the first opening is located on the base end side of the document load tray while the second opening located on the free end side of the document load tray.

4. The document feeder according to claim 1, further comprising ribs extending longitudinally along the duct, locating between the ducts and at the both side of the ducts and which have a larger height than the duct, the ribs each having an inclined surface for preventing the document ejected from a document feeder body from being caught on the ribs and the duct.

5. An image forming apparatus comprising:
the document feeder according to claim 1, and
an image forming section configured to carry out an electrophotographic image forming process based on document data supplied from the document feeder.
